(19) United States
(12) Patent Application Publication
(10) Pub. No.: US 2007/0295432 A1
(43) Pub. Date: Dec. 27, 2007

(54) Tire having wear indication means and a method of manufacturing the tire

(76) Inventors: Carlos Santiago Restrepo Posada, Cali (CO); Luis Fernando Montoya Villegas, Cali (CO); Alonso Arturo Santana Gonzales, Cali (CO); Jeffrey Lee Plauny, North Canton, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/472,594

(22) Filed: Jun. 22, 2006

(51) Int. Cl. B60C 11/24; B29D 30/08

(52) U.S. Cl. 152/154.2; 152/209.1; 156/128.1

(57) ABSTRACT

A pneumatic tire has a tread with at least one groove having a groove depth Dg extending from an initial tread surface to the base of the groove. The tread has at least one tread wear indicator having at least two different colored portions. The tread wear indicator is a strip inclined at an angle relative to the tread surface and extending to a depth Dr at least equivalent to the groove depth Dg. In manufacturing the tire, the tread wear indicator is applied to a splice cut edge of the tread rubber such that, after splicing the tread rubber, the tread wear indicator strip is located within the tread splice.

### FIELD OF THE INVENTION

The present invention is directed to a tire and a method of manufacturing a tire. More specifically, the present invention is directed to a tire having an inclined wear indicator strip and a method of manufacturing a tire having a multi-colored strip built into the tire.

### BACKGROUND OF THE INVENTION

The use of treadwear indicators is not new and the use of treadwear indicators is mandated by law in many countries. A variety of such indicators are known. Once such type employs colored means, such as different colored rubber layers incorporated into the tread or colored fibers in layers located below the tread for a visual indicator of wear. Other types use tie-bar type elements in the tread grooves. When required by law, the upper surface of the tread wear indicator must be located at a height of 1.6 mm from the base of the groove in which the wear indicator is located.

The practical problem with the colored indicators of the type mentioned is that there is no way for the operator to determine the level of wear until the tire is worn and the buried colored rubber layer or colored fiber is finally exposed. When the tire employs the tie-bar type wear indicator, since the wear indicator is the same color as the remaining part of the tread, it can be difficult to determine the level of wear.

### SUMMARY OF THE INVENTION

The present invention is directed to a tire having located within the tread structure, a visual tread wear indicator that provides a visual means of indicating the state of wear for the full tread depth. Also disclosed is a method of manufacturing a tire having such a tread wear indicator within the tread.

Disclosed herewith is a pneumatic tire comprising a tread, a belt structure, and a carcass, the tread having at least one groove. The tread has a groove depth Dg extending from an initial tread surface to the base of the groove. The tread is defined by a particular color; this color conventionally being considered black, though varying shades of black or very dark grey may define the tread color. The tread has at least one tread wear indicator, the tread wear indicator comprising at least two different colored portions. The different colors of the tread wear indicator differ from the tread color. The tread wear indicator is a strip inclined at an angle relative to the tread surface and extending to a depth Dr at least equivalent to the groove depth Dg.

In another aspect of the invention, the tread wear indicator strip has a defined length L and at least the radially outer portion of the strip, having a length of at least 50% of the length L of the strip, is formed from one of the at least two different colors.

In another aspect of the invention, the tread wear indicator strip has a defined length L and at least the radially inner portion, having a length of at most 50% of the length L of the strip, is formed from two different colors, the strip having three different colors.

In another aspect of the invention, tread wear indicator strip is inclined at an angle of not more than 60° relative to the surface of the tread. Alternatively, the tread wear indicator strip may be inclined at an angle of 45° to 20° relative to the surface of the tread.

In another aspect of the invention, the tire has a rubber layer radially outward of the belt structure, this rubber layer not forming part of the tread. In such a tire construction, the tread wear indicator strip may extend to a depth Dr radially outward of the radially outer surface of the rubber layer.

Also disclosed is a method of manufacturing a tire having at least one wear indicator strip therein. The tire has a tread having a tread color, a belt structure, and a carcass. The method of manufacturing comprising the following steps: a) assembling the carcass, b) assembling the belt structure to the outer surface of the carcass, c) applying a tread rubber outward of the belt structure, the tread rubber having a first and second splice cut edge, d) splicing the tread rubber to form a unitary circle of tread rubber, and e) curing the tire. To provide for the tread wear indicator, prior to splicing the tread rubber, at least one tread wear indictor strip is applied to a splice cut edge of the tread rubber such that, after splicing the tread rubber, the tread wear indicator strip is located within the tread splice.

In one aspect of the disclosed manufacturing method, the first and second splice cut edges of the tread rubber are inclined at an angle of less than 60° relative to the radially inner surface of the tread rubber.

In another aspect of the disclosed manufacturing method, the tread wear indicator strip is comprised of at least two different colored portions.

In another aspect of the disclosed method, the tread wear indicator strip has a length in the range of 95-105% of the length of the splice cut edges of the tread.

In another aspect of the disclosed method, one to three tread wear indicator strips are applied to the first splice cut edge of the tread rubber.

In another aspect of the disclosed method, multiple splices along the circumferential length of the tread rubber are provided, and at least one tread wear indicator strip in the each splice.

### BRIEF DESCRIPTION OF THE DRAWINGS

The invention will be described by way of example and with reference to the accompanying drawings in which:

FIG. 1 is a cut perspective view of a tire illustrating the tread wear indicator;

FIG. 2 is a cross-sectional view of the tire;

FIG. 3 is a tread wear indicator strip;

FIG. 4 is a roll of rubber material to be used to form the tread wear indicators;

FIG. 5 is a cross-section view of the tire as it being assembled; and

FIG. 6 is a cut perspective view of a lugged tire having a tread wear indicator.

### DETAILED DESCRIPTION OF THE INVENTION

The following language is of the best presently contemplated mode or modes of carrying out the invention. This description is made for the purpose of illustrating the general principles of the invention and should not be taken in a limiting sense. The scope of the invention is best determined by reference to the appended claims. The reference numerals as depicted in the drawings are the same as those referred to in the specification.

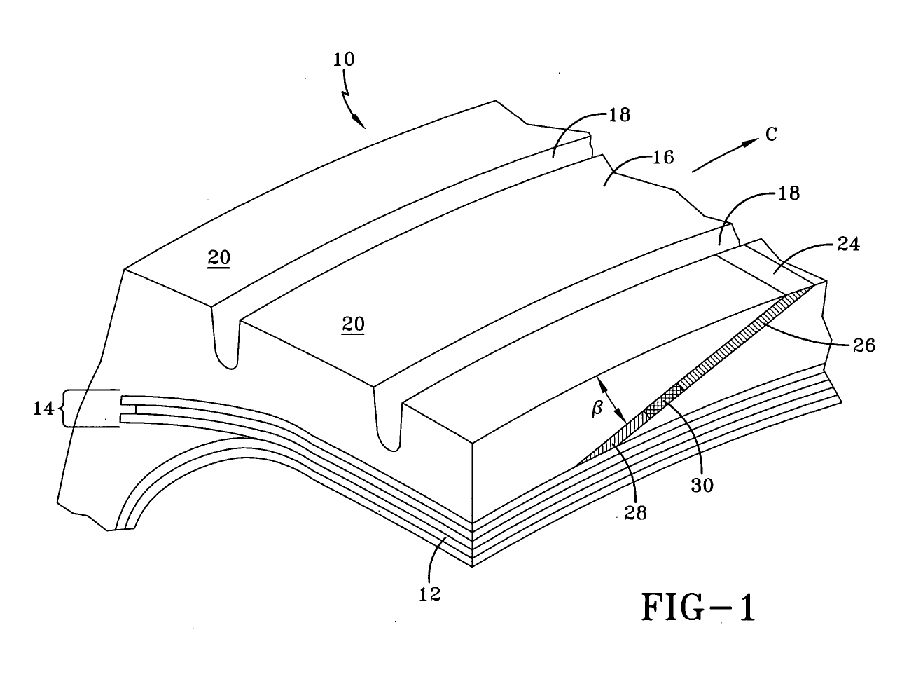

FIG. 1 illustrates a sectional view of a tire 10 in accordance with the present invention. The tire 10 has a carcass, formed of at least one ply 12 of reinforcing cords, a belt structure 14, having at least two plies of reinforcing cords located radially outward of the carcass reinforcing ply, and a tread 16 located radially outward of the belt structure. While the illustrated tread 16 has several circumferentially extending grooves 18 and ribs 20, the specific tread pattern is dependent upon the desired characteristics and use of the tire 10.

Located within the tread 16 is a tread wear indicator means. The tread wear indicator means is a strip of rubber 24 inclined at an angle β relative to the surface of the tread 16 and the circumferential direction C of the tire 10. The strip 24 has at least two portions along its length having colors different from the black color of the tread rubber. The configuration of the strip 24 is selected to have colors and a length to alert drivers to the wear level of the tire.

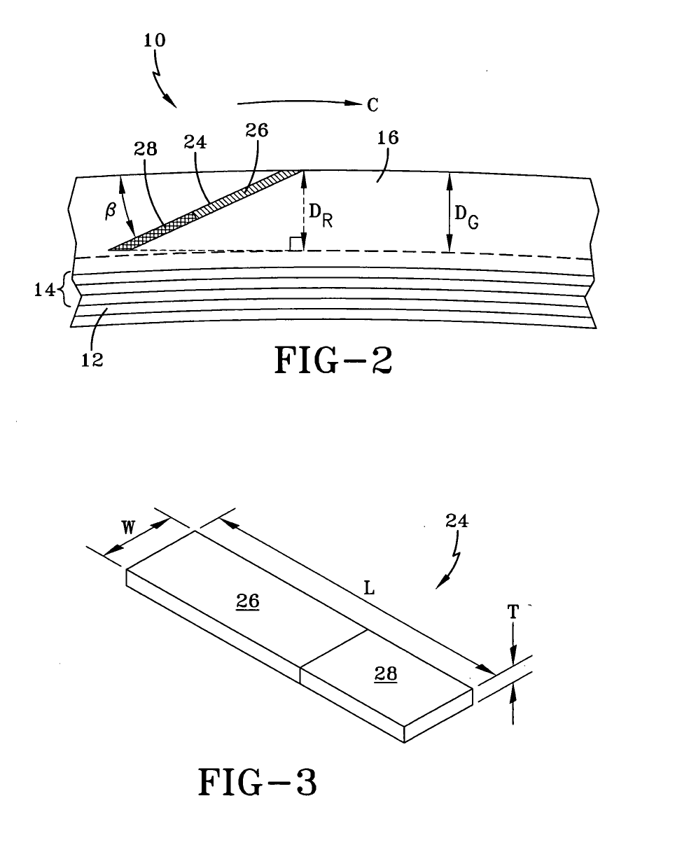

In the tire of FIG. 1, the strip 24 extends from the tread surface to the radially outer surface of the belt structure. At a minimum, the strip 24 has a length L so that it extends to a depth Dr that is at least equivalent to the groove depth Dg in the tread 16, see FIGS. 2 and 3. If the tire structure radially outward of the belt structure 14 includes at least one rubber layer that does not form part of the actual tread structure, such as a cushion layer or a tread base layer, the strip extends to a depth Dr radially outward of the radially outermost surface of the non-tread rubber layer. For such a construction, the strip 24 preferably extends to a depth Dr within the range of 95-105% of the depth Dt of the rubber layer that forms the actual tread structure. Calculation of the length L can be made by using the approximation that the strip of rubber 24 forms the hypotenuse of a right angle triangle; the length L is then equal to the Dr/(sin β).

The strip 24 has at least two non-black colored portions 26, 28 along its length. If the strip has only two non-black colored portions, the radially outermost portion 26, having a length of at least 50%, preferably at least 60%, of the strip length L, will have a color indicating an acceptable tread depth to the vehicle operator. The selected color should indicate a “go” or “okay” and includes green, blue, or white, and any color selected can be a fluorescent or non-fluorescent color. Along the remaining length, forming the radially inner portion 28 of the strip 24, the color selected should be a color associated as a cautionary, warning, or stop color, such as yellow, orange, or red. Again, the color may be a fluorescent or non-fluorescent color.

If the strip 24 is comprised of three colors, at least the radially outermost portion 26, having a length of about 50-60% of the strip length L, will have a color indicating an acceptable tread depth. The radially inner portion 28, having a length of at most 50% of the strip length, is divided into two colors, wherein, preferably, the central colored portion 30 of the strip is a cautionary color, such as yellow or orange, and the radially innermost color is a stop color such as red. The relative lengths of the two radially inner colors may be equally divided, or have unequal lengths.

The strip 24 may be comprised of more than three colors, if so desired. The maximum number of colors is limited by the length of the strip and how many colors can be arranged along the length of the strip 24. One example of a more than three colors would be a gradual rainbow type shading. Additionally, the design tread depth and any legal limit on tread depth factor into a determination of the number and length of the different colored portions of the strip 24.

The inclination angle β of the strip 24 is preferably in the range of not more than 60° relative to the surface of the tire 10. Preferably, the inclination angle β is in the range 45° to 20° for passenger vehicle tires, 60° to 20° for truck tires, and 35° to 5° for specialty tires having a tread depth that is less than conventional for a passenger vehicle tire. As can be extrapolated from the above angle ranges, the thicker the tread, the larger the inclination angle permissible. This correlation occurs because of the manner in which the tire is manufactured, as discussed below.

FIG. 3 illustrates a single strip 24 to be used as the tread wear indicator in a tire. The strip has a length L, a width W, and a defined thickness T. The illustrated strip 24 is divided into two color portions 26, 28. Though the dimensions for the strip length L, width W, and thickness are selected based upon the size of the tire being manufactured, the strip will generally have a length L in the range of 30 to 80 mm, a width W in the range of 5 to 30 mm, and a thickness T in the range of 0.5 to 2.0 mm.

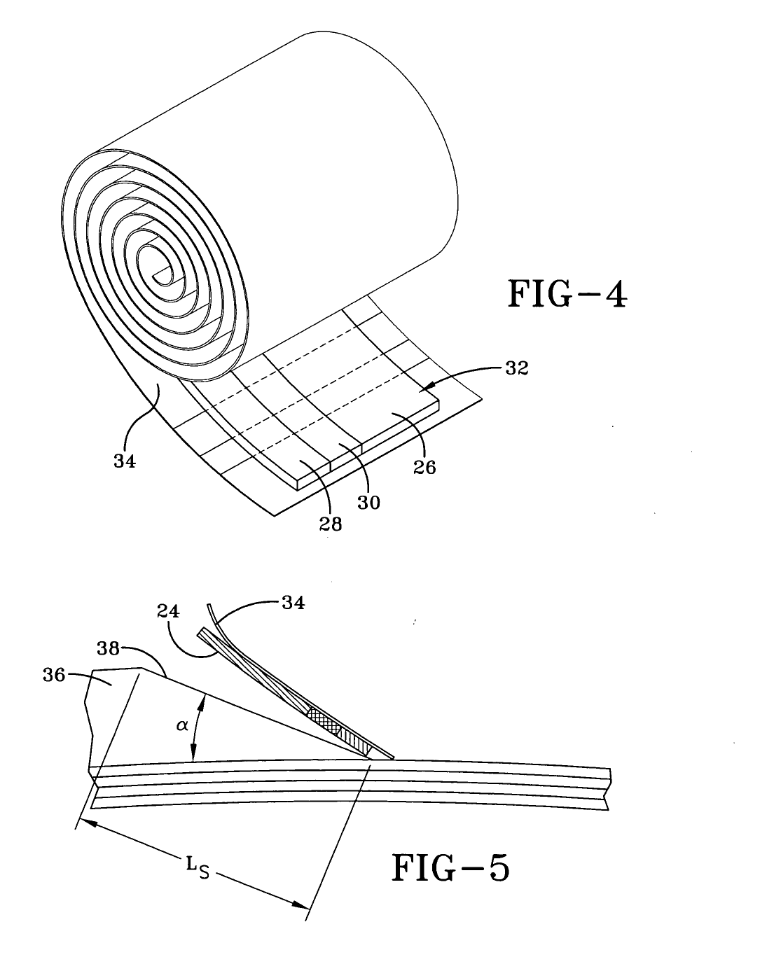

While the strips 24 may be manufactured individually, for ease of manufacturing, a length of material that can be divided into individual strips has greater manufacturing viability. FIG. 4 illustrates a roll of a length of material 32 useful for forming the individual wear indicator strips 24. The length of material 32 is an uncured, or partially cured, strip, having three different color portions 26, 28, 30. The length of material 32 is on a release sheet 34; the release sheet 34 preventing the uncured, or partially cured, material 32 from sticking to itself when in roll form. When using the material roll, a portion of the length of material 32 is cut to a width W to create the strip of FIG. 2.

The tire 10 may be formed in either a two stage build operation or a single stage build operation. The selection of build process may depend upon the type of tire being formed, or processing limitations of the plant.

For a two-stage build operation, during the first build stage the carcass structure of the tire, including reinforcing plies 12 turned around bead cores in the bead areas of the tire, and tire sidewalls, is formed. This carcass structure is expanded to create a green, or uncured, torodial structure. A pre-assembled belt structure 14 and tread is applied to the green carcass. This pre-assembled tread belt is built on a separate building drum. When assembling the tread belt, the uncured tread rubber 36 is applied and spliced to form a unitary circle of tread rubber.

For a single build stage operation, the entire tire is built on a single drum. The carcass structure of the tire is prepared on the drum, including reinforcing plies 12 turned around bead cores in the bead areas of the tire. The plies of the belt structure 14 are then applied. Next, the uncured tread rubber is applied and spliced to form a unitary circle of tread rubber. The rubber sidewalls may be applied either before or after the tread rubber depending on the build specifications of the tire. The fully assembled uncured tire is then removed from the building drum and is cured.

In accordance with the invention, after the tread rubber 36 is first applied to a building drum to the form the unitary circle of tread rubber, regardless of which type of tire building operation is employed, the tread wear indicator strip 24 is laid upon one of the splice cut edge 38 of the tread rubber 36, see FIG. 5 which shows application of the tread wear indicator during a single build stage operation. The splice cut edge 38 of the tread rubber 36 has a length Ls and is inclined relative to the radially inner surface of the tread rubber 36. The inclination angle α is not more than 60°, preferably in the range of 45°-20°. The non-illustrated other splice cut edge of the tread rubber is a mirror image of the illustrated splice cut edge 38. While illustrated as being applied to the first splice cut edge 38 applied to the uncured tire, the tread wear indicator strip 24 may be applied to either splice cut edge. The inclination angle of the splice cut edges creates the corresponding inclination of the tread wear indicator strip 24 in the cured tire 10.

If the tread wear indicator strip 24 is cut from a roll of material 32 and the release sheet 34 is also cut with the wear indicator strip 24, the release sheet 34 can be used to aid positioning of the strip 24 upon the splice cut edge 38. After the strip 24 is located where desired, the release sheet 34 is removed. After the tread wear indicator strip 24 is applied to the cut edge, the uncured tread rubber 36 is fully wound upon the uncured tire and the second splice cut edge, having a cut edge corresponding to the first splice cut edge, is matched up to the first splice cut edge 38. The cut edges are then spliced in any conventional manner to form a unitary circle of rubber on the uncured tire. The result is that the tread wear indicator strip 24 is held, or located, within the tread rubber splice. The tire is then cured.

FIG. 5 illustrates only a single tread wear indicator strip 24 being placed in the tread splice; however, multiple tread wear strips 24 may be placed in the splice. The number of wear indicators in a single tread splice is in the range of one to five, with a preferred number of indicators being two or three indicators evenly spaced from each other along the lateral width of the tire tread 16.

While a single splice is typical for tread application in tires, to provide tread wear indicators in more than one location along the tire circumferential length, either the tread rubber stock may be provided with multiple splices along the tire circumferential length, or slices may be made in the applied tread stock that allow the builder to insert a tread wear indicator strip into the uncured tread rubber. When multiple tread wear indicators in the tire are desired, a preferred number of wear indicators is at least three indicators spaced relatively equally along the circumferential length of the tire.

To ensure bonding of the tread wear indicator strip in the tire, preferably the tread wear strip 24 is formed from rubber. Any suitable rubber may be used, and ideally will have a base elastomeric blend similar or highly compatible with the rubber forming the tread. Use of an additional adhesive, such as those used in retreading procedures, may also be used to secure bonding of the tread wear indicator strip 24 in the tire 10. However, the strip may also be formed from other materials that can be placed and held within the tread splice; the primary requirement of such a material being that it be capable of being adhesively bonded to the tread rubber and not destroy the integrity of the tread splice in the cured tire 10.

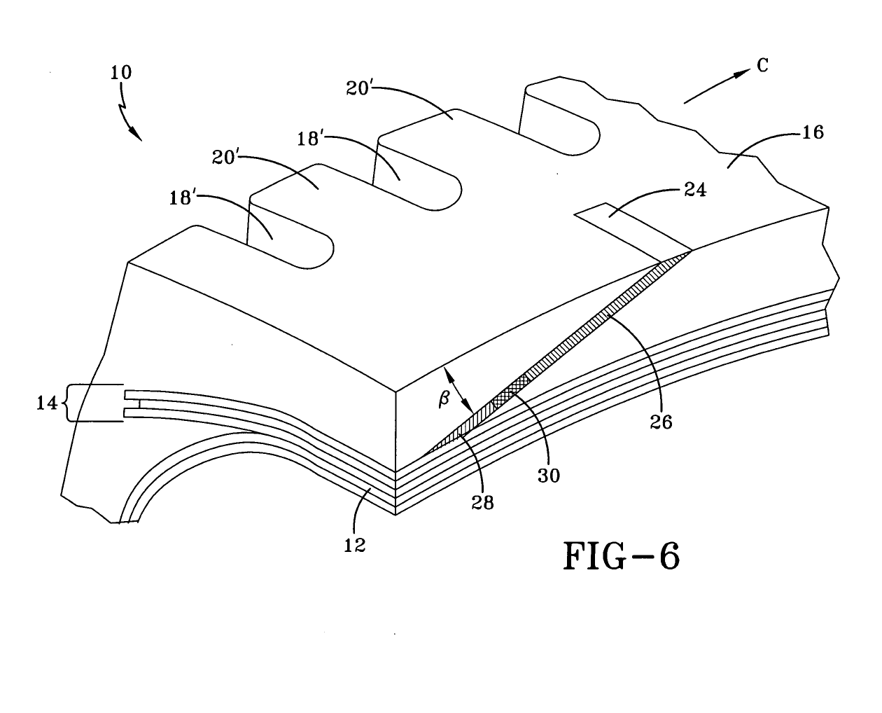

FIG. 6 illustrates the use of the tread wear indicator 24 in a tire 10 wherein the tread 16 is provided with a plurality of laterally extending lug grooves 18′ forming lugs 20′. The illustrated tread wear indicator 24 extends laterally across the tread from the tread edge to an internal tread location.

Rather than having a wear indictor that is only visible once tread wear begins to reach an unacceptable level, the present invention will provide vehicle operators with a visual continual notice as to the level of tread wear of their tires.

What is claimed is:

1. A pneumatic tire comprising a tread, a belt structure, and a carcass, the tread having at least one groove, a groove depth Dg extending from an initial tread surface to the base of the groove, and a tread color, the tread comprising at least one tread wear indicator, the tread wear indicator comprising at least two different colored portions, the at least two different colors differing from the tread color, the tread wear indicator being characterized by:
the tread wear indicator being a material strip, the material strip being inclined at an angle relative to the tread surface, and extending to a depth Dr at least equivalent to the groove depth Dg.

2. The tire of claim 1 wherein the tread wear indicator strip has a length and at least the radially outer portion having a length of at least 50% of the length of the strip is formed from one of the at least two different colors.

3. The tire of claim 1 wherein the tread wear indicator strip has a length and the radially inner portion having a length of at most 50% of the length of the strip being formed from two different colors, the strip having three different colors.

4. The tire of claim 1 wherein the tread wear indicator strip is inclined at an angle of not more than 60° relative to the surface of the tread.

5. The tire of claim 1 wherein the tread wear indicator strip is inclined at an angle of 45° to 20° relative to the surface of the tread.

6. The tire of claim 1 wherein the tire is further comprised of a rubber layer radially outward of the belt structure, the rubber layer not forming part of the tread, and wherein the tread wear indicator strip extends to a depth Dr radially outward of the radially outer surface of the rubber layer.

7. A method of manufacturing a tire, the tire comprising a tread, a belt structure, and a carcass, the tread having a tread color and at least one tread wear indicator, the method of manufacturing comprising the following steps:
assembling the carcass,
assembling the belt structure to the outer surface of the carcass,
applying a tread rubber outward of the belt structure, the tread rubber having a first and second splice cut edge,
splicing the tread rubber to form a unitary circle of tread rubber, and curing the tire,
wherein, prior to splicing the tread rubber, the method has the further step of applying at least one tread wear indictor strip to a splice cut edge of the tread rubber such that, after splicing the tread rubber, the tread wear indicator strip is located within the tread splice.

8. The method of claim 7 wherein the first and second splice cut edges of the tread rubber are inclined at an angle of less than 60° relative to the radially inner surface of the tread rubber.

9. The method of claim 7 wherein the tread wear indicator strip is comprised of at least two different colored portions.

10. The method of claim 7 wherein the tread wear indicator strip has a length in the range of 95-105% of the length of the splice cut edges of the tread.

11. The method of claim 7 wherein one to three tread wear indicator strips are applied to the first splice cut edge of the tread rubber.

12. The method of claim 7, the method further comprising the step of providing multiple splices along the circumferential length of the tread rubber, and placing at least one tread wear indicator strip in the each splice.
